(19) United States
(12) Patent Application Publication
(10) Pub. No.: US 2012/0284035 A1
(43) Pub. Date: Nov. 8, 2012

(54) Method and Apparatus for Registering Closed and Open Loop Prepaid Gift Cards and Other Prepaid Card Products

(75) Inventor: Matthew J. Gillin, Villanova, PA (US)

(73) Assignee: RELAY NETWORK, LLC, Radnor, PA (US)

(21) Appl. No.: 13/098,958

(22) Filed: May 2, 2011

(51) Int. Cl. G06Q 99/00; G06Q 30/00

(52) U.S. Cl. 705/1.1

(57) ABSTRACT

A method and system is provided through which a purchaser and/or a recipient of a prepaid card (e.g., gift card) may enroll in a prepaid card protection, loyalty program, or other service. By enrolling the purchaser and/or recipient of the prepaid card for this service, the purchaser and/or recipient become known to the prepaid card vendor for marketing and tracking purposes. The merchant and/or prepaid card administrator may thus make the prepaid card registrant aware of special offers that may entice the prepaid card registrant to go to the merchant's store to use the prepaid card.

### TECHNICAL FIELD

The present disclosure relates to an electronic communication system and method and, more particularly, to a system and method for registering closed and open loop prepaid gift cards and other prepaid card products even in those situations where cardholder information is not known.

### BACKGROUND

Gift cards have become increasingly popular in recent years. Typically, gift cards are purchased for a given face amount (e.g., $100) and the merchant selling the card charges a small fee for activating the gift card. Gift cards come in two general varieties: so-called closed loop gift cards that provide customers of a merchant with gift dollars to use with that merchant (e.g., a Home Depot™ gift card purchased at Home Depot™) and a so-called open loop gift card that allows the recipient to use the gift card with a variety of merchants that accept that gift card (e.g., a Visa™ gift card usable wherever Visa™ is accepted). Such gift cards may be plastic cards adapted to contain value information or may be virtual cards (an account number but no physical card) that are provided to the purchaser electronically. However, gift cards and other prepaid card products have several drawbacks for the merchant. For example, the purchase of the prepaid card product is charged against the merchant's accounts sometimes long before the actual purchase is made with the prepaid card product. Also, many gift cards go unused for months because the gift cards are lost or misplaced. Furthermore, the recipient and often even the purchaser of the prepaid card product are unknown to the merchant. As a result, the merchant can do nothing to entice the prepaid card holder to use the prepaid card in connection with a sales promotion and is generally powerless to market to the prepaid card holder. In addition, prepaid cards are usable as cash and thus may be lost or stolen and used by others typically without recourse for replacement.

A technique is desired that would provide a simple mechanism for the purchasers and/or recipients of open and/or closed loop gift cards and other prepaid cards to register their prepaid cards so that the value of the prepaid card may be protected against loss or theft and so that other services may be offered to the registrants. Also, such enrollment is desired to provide a mechanism for the merchant to make the prepaid card holder aware of sales promotions so that the prepaid card holder will use the prepaid card sooner rather than later and enhance loyalty to the merchant, thus allowing the merchant to obtain the benefit of the sale while better tracking its outstanding prepaid cards and better administering its loyalty programs. The present invention addresses these needs in the art.

### SUMMARY

Disclosed herein are systems and methods that address the above needs in the art by allowing a purchaser and/or a recipient of a gift card or other prepaid card to enroll in a prepaid card protection service that enables a prepaid card vendor, retailer, or issuer to deactivate a lost or stolen prepaid card and to replace the lost or stolen prepaid card with a new one. Also, by enrolling the purchaser and/or recipient of the prepaid card for this service, the purchaser and/or recipient become known to the prepaid card vendor, retailer or issuer for marketing and tracking purposes. The merchant may thus make the prepaid card registrant aware of special offers that may entice the prepaid card registrant to go to the vendor's, retailer's or issuer's store to use the prepaid card.

In accordance with an exemplary embodiment of the method of the invention, a label is provided on a prepaid card that instructs the purchaser to activate the prepaid card for a service such as theft and loss protection by texting a specified keyword to a text short code. In the case of an open loop gift card, the purchaser may alternatively be instructed to text the last 4 digits of the gift card number and other identifying information such as full name to the specified text short code. Upon receipt of the texted information, the server of the service administrator (vendor, retailer, or issuer) may determine the program that the prepaid card was sold under, capture the registrant's name and phone number, capture or confirm the registrant's account number from the prepaid card, and confirm the registrant's consent to enrolling in the offered card replacement service and in receiving sales promotions, etc. from the vendor, retailer or issuer. After this brief exchange of texts, a confirming text is provided to the prepaid card registrant. A report also may be generated by the administrator's server. In the exemplary embodiment, the registrant's information also may be linked with the registrant's mobile phone number after a response is received and then further linked to other stored information tied to the registrant's mobile phone number. In an exemplary embodiment, the registrant's text messages would be free to end user SMS text messages, whereby no cost is incurred by the registrant for receiving the text messages from the vendor, retailer or issuer.

An exemplary embodiment of the method of enrolling a prepaid card holder in a service, such as a lost and stolen protection service for the prepaid card, offered by an entity includes the steps of receiving a keyword, a full or partial card/account number, and/or personal identifying information from a prepaid card holder in response to an invitation to enroll in a service offered by a vendor, retailer or issuer of the prepaid card, capturing the mobile phone number of the prepaid card holder, presenting an invitation to the prepaid card holder via a communications medium and instructing the prepaid card holder to enroll from the prepaid card holder's mobile phone, and capturing the prepaid card holder's response from the registrant's mobile phone. In the exemplary embodiment, the keyword is received via SMS text messaging to an SMS text short code. Upon receipt of the keyword, full or partial card/account number, and/or personal identifying information from the prepaid card holder, the promotional program that the prepaid card was sold under may be determined. The registrant's name, account number from the prepaid card, and consent to enroll in the offered service may also be captured. As desired, the account information for the registrant held by the vendor, retailer or issuer may be tied to the prepaid card registrant using the captured mobile phone number.

The scope of the invention also includes a communications platform (server) that is programmed to implement the prepaid card services described herein.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Exemplary embodiments of the invention will be described in connection with the associated figures, of which:

FIG. 1 illustrates closed and open loop gift cards with activation labels instructing the recipient to text a keyword or other identifying information to a text short code in order to activate the gift card and/or to activate a lost & stolen protection service.

FIG. 2 illustrates a gift card with an activation label for instructing the recipient to text a keyword to a text short code in order to activate a loyalty program.

FIG. 3 illustrates sample embodiments of account numbers that may be pulled off the gift card for registration by the registrant.

FIG. 4 illustrates registration of the gift card of FIG. 3(a).

FIG. 5 illustrates registration of the gift card of FIG. 3(b).

FIG. 6 illustrates an example embodiment of a system for enabling prepaid card purchasers and/or recipients to activate prepaid cards for services while providing limited personal information.

FIG. 7 illustrates an example embodiment of a method for enrolling prepaid cards for services in accordance with the invention.

FIG. 8 illustrates an example embodiment of a method for enrolling a prepaid card recipient in a new service where the recipient's mobile phone number is linked to account information for the recipient after the recipient has enrolled in the new service.

### DETAILED DESCRIPTION OF ILLUSTRATIVE EMBODIMENTS

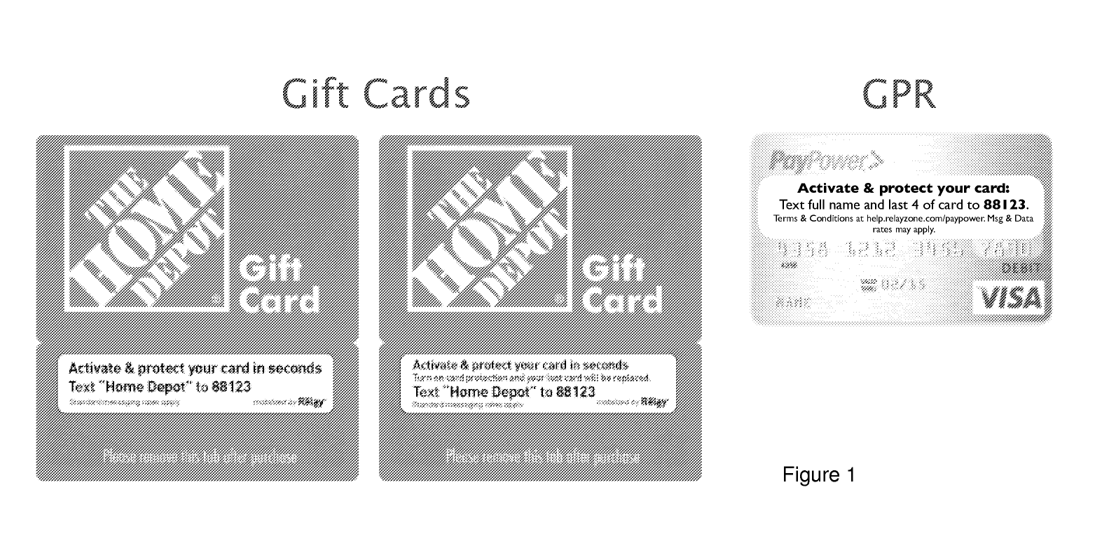

A detailed description of illustrative embodiments of the present invention will now be described with reference to FIGS. 1-8. Although this description provides a detailed example of possible implementations of the present invention, it should be noted that these details are intended to be exemplary and in no way delimit the scope of the invention.

Disclosed herein are systems and methods of enrolling a gift card or other prepaid card purchaser and/or recipient (“prepaid card registrant”) in a service offered by the prepaid card vendor, retailer or issuer (hereinafter “vendor”). The systems and methods described herein may be used to provide a prepaid card enrollment service that acquires mobile phone numbers and service consent so that the vendor may provide a value added service to its clients and cardholders. For example, a premium lost and stolen protection plan may be provided that safeguards the registrants prepaid card balance when the card is lost or stolen, irrespective of whether the registrant has a purchase receipt. The terms gift card and prepaid card are used interchangeably herein, although those skilled in the art will appreciate that a gift card is a type of prepaid card. Also, the prepaid card need not be a physical card made of plastic or the like but may also be a virtual prepaid card.

In the exemplary embodiments of FIG. 1, closed and open loop gift cards are provided with activation labels instructing the recipient to text a keyword or other identifying information to a text short code in order to activate the gift card and/or to activate a lost & stolen protection service. Of course, the label could alternatively request that the gift card holder call a number or access a website to activate the card and/or activate the lost & stolen protection service. In the indicated embodiment, the closed loop gift cards are shown to include a label indicating to the card holder that the card may be activated and/or protected by texting a keyword (in this case “Home Depot”) to a text short code (in this case “88123”). Generally speaking, the keyword and/or text short code identify a corresponding client account or promotion of the recipient vendor. Similarly, in the case of an open loop gift card such as a Visa™ gift card, the label instructs the card holder to activate and/or protect the card by texting the card holder's full name and the last 4 digits of the card number to the text short code (“88123”).

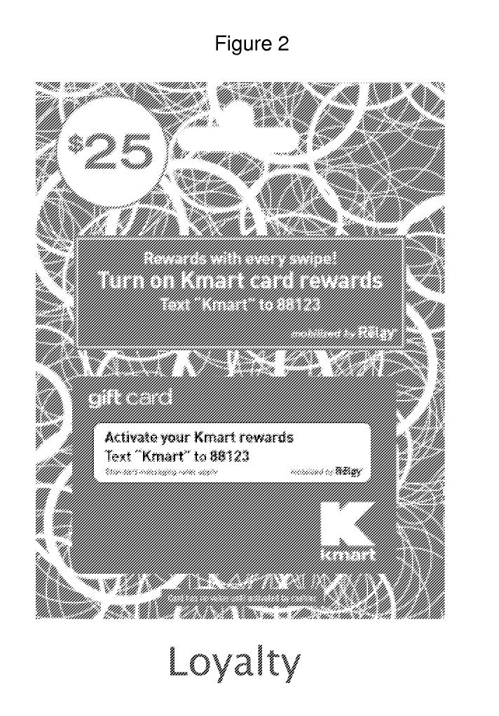

The activation technique described herein is not limited to lost and stolen card protection. For example, FIG. 2 illustrates a gift card with an activation label for instructing the recipient to text a keyword (in this case “Kmart”) to a text short code (“88123”) in order to activate a loyalty program. Those skilled in the art will appreciate that the techniques described herein may be used to similarly activate other types of card services such as discount programs, coupon programs, alert services, and the like.

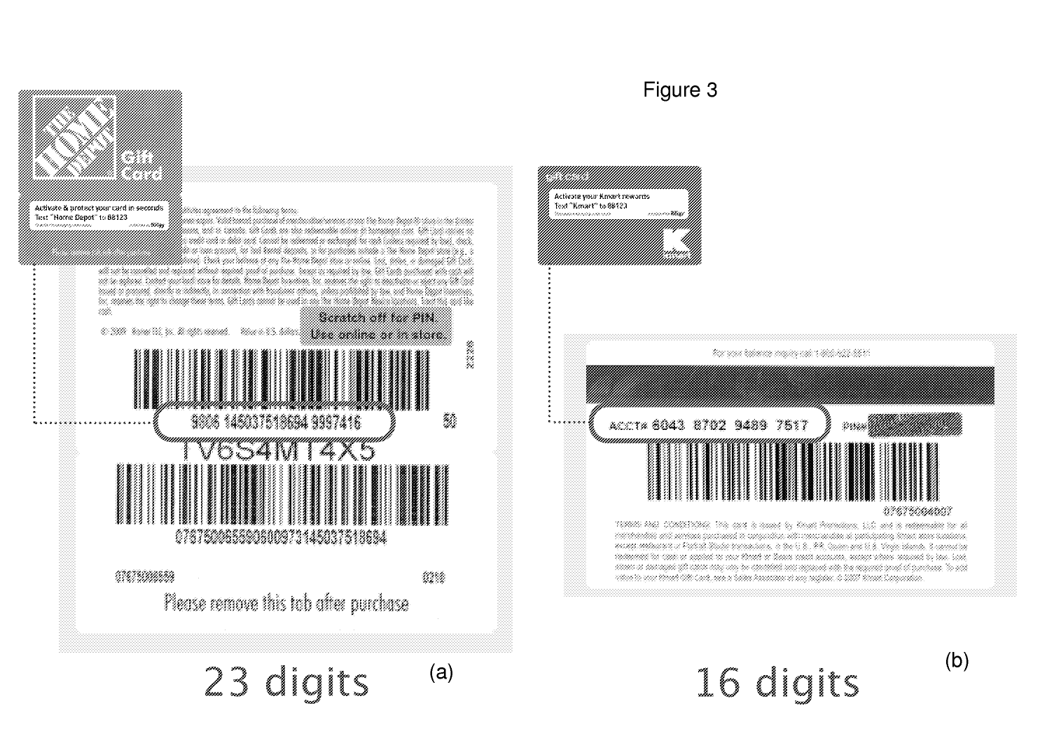

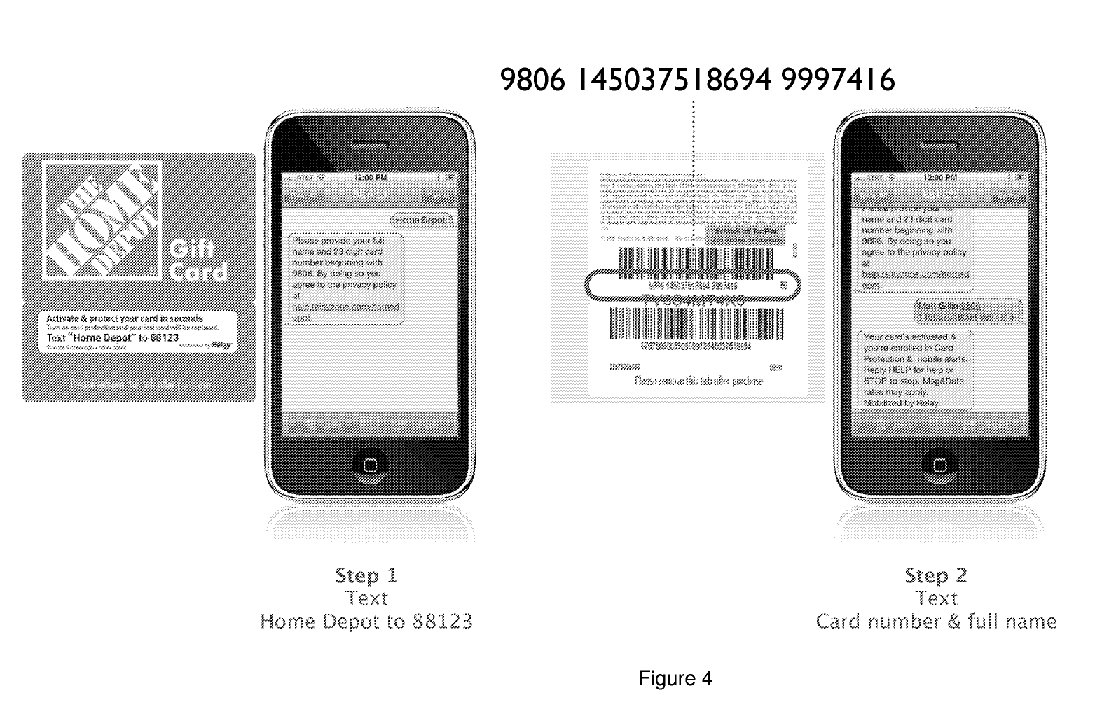

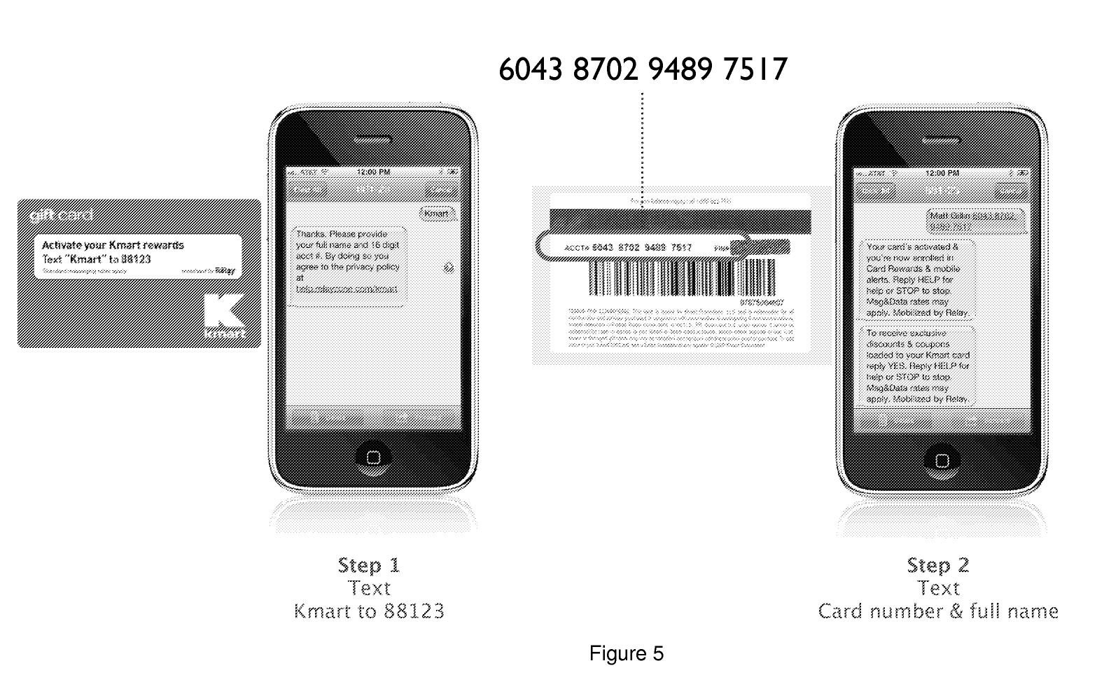

FIG. 3 illustrates sample embodiments of account numbers that may be pulled off the gift card for registration by the registrant. As illustrated, the gift card may have a unique 23-digit (FIG. 3(a)) or 16-digit (FIG. 3(b)) account number on the back of the gift card that may be entered during the registration process to uniquely identify the gift card being registered. FIG. 4 illustrates the process of registration of the gift card of FIG. 3(a), while FIG. 5 illustrates registration of the gift card of FIG. 3(b). In each case, upon texting the keyword to the text short code, the registrant is instructed in a reply text to enter his/her name and card number if he/she consents to the terms of the privacy policy. Upon receipt of this information in a text from the registrant, a reply text is provided to the registrant indicating that the card is activated and enrolled in the service (in this case, a Card Protection and mobile alert service). In the exemplary embodiments, the registrant's text messages are preferably free to end user SMS text messages, whereby no cost is incurred by the registrant for receiving the text messages from the vendor.

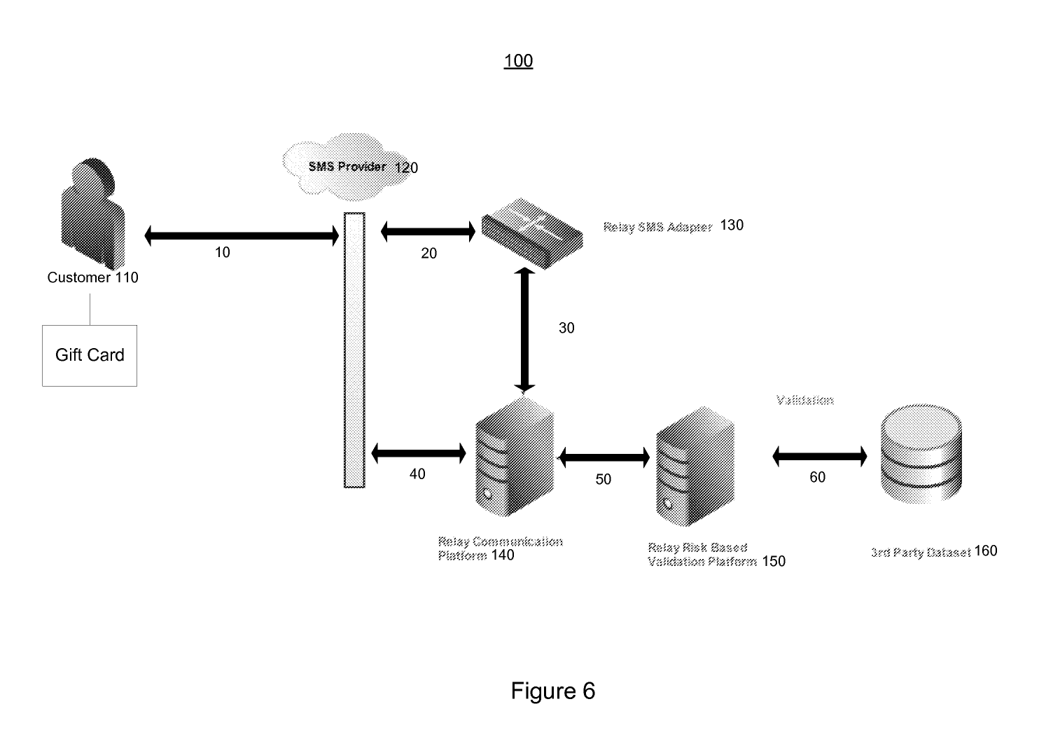

FIG. 6 illustrates an example embodiment of a system for enabling prepaid card purchasers and/or recipients to activate prepaid cards for services while providing limited personal information. This system may be used, for example, to acquire a card holder's permission to activate a prepaid card, activate a new service such as lost and stolen protection or a loyalty program, and the like.

As shown in FIG. 6, the system 100 includes relay communication platform 140. Relay communication platform 140 may be a computer, a mainframe, a server, or the like. According to an example embodiment, relay communication platform 140 may include hardware components and/or software components such that relay communication platform 140 may be used to execute applications such as internet applications, operating systems, server applications, client applicants, database applications, or the like. For example, relay communication platform 140 may be used to execute software that may activate and enroll registrant's prepaid cards using the techniques described herein.

In an example embodiment, relay communication platform 140 may further include a processor that may be in operative communication with a memory component. The processor may include a standardized processor, a specialized processor, a microprocessor, or the like. The processor may execute instructions including, for example, instructions for activating a prepaid card and enrolling a registrant in a service using text messaging, as described in more detail herein.

Relay communication platform 140 may further include a memory component that may store the instructions that may be executed by the processor. The memory component may include a tangible computer readable storage medium in the form of volatile and/or nonvolatile memory such as random access memory (RAM), read only memory (ROM), cache, flash memory, a hard disk, or any other suitable storage component. In one embodiment, the memory component may be a separate component in communication with relay communication platform 140. According to another embodiment, the memory component may be integrated into the processor.

As shown in FIG. 6, relay communication platform 140 may be in communication with Short Message Service (SMS) provider 120, relay SMS adapter 130, and relay risk based validation platform 150 via communication links 30, 40, and/or 50. Communications links 30, 40, and/or 50 may be wired connections including, for example, a USB connection, a Firewire connection, an Ethernet connection, or the like and/or a wireless connection such as wireless 802.11n connection, a radio connection, a cell phone connection, or the like.

As explained further below, relay communication platform 140 also may enable a business to passively acquire a registrant's phone number and link the registrant's phone number to existing account information for the registrant without requesting the registrant to actively provide identifying information. For example, relay communication platform 140 may enable a vendor to passively acquire a phone number for registrant 110 and link the phone number for registrant 110 to an account for registrant 110 without requesting registrant 110 to actively provide identifying information. The account for registrant 110 may be taken from the database of a transaction partner, such as a corporation that has significant customer transactions; a communication partner, such as a corporation that may have incomplete electronic contact information; or a data partner, such as a company that has data that may be used to enhance an address profile. Registrant 110 may be an existing customer of a business, such as a customer of a cell phone provider, an internet provider, a cable television provider, a utility company, a bank, a merchant, or the like. Techniques for such account matching and registrant identification are described, for example, in U.S. patent application Ser. No. 12/709,312, filed Feb. 19, 2010, the contents of which are incorporated herein by reference.

To passively acquire a registrant's phone number and link that registrant's phone number to the registrant's account (if any) without requesting the registrant to actively provide identifying information, relay communication platform 140 may identify the registrant using his/her mobile telephone number, by name, and/or by account number taken from the prepaid card. Also, as desired, a proxy code may be generated based on a fingerprinting algorithm or other secure algorithm that may allow the registrant 110 to activate a new prepaid card and/or a new service without revealing the identity of registrant 110.

As noted above, the prepaid card is provided with a label including an invitation to activate the prepaid card and/or to open a new account or receive a new service. When the prepaid card registrant purchases or receives the prepaid card as a gift, the registrant may elect to activate the prepaid card and/or new service by returning the keyword or other identifying information such as name and partial card number via SMS text message to the relay communication platform 140.

In one example embodiment, registrant 110 may transmit the keyword to relay communication platform 140 through SMS provider 120. For example, registrant 110 may transmit a text message via communication link 10 to SMS provider 120 where the text message may then be transmitted to relay communication platform 140 via communication link 40. Communications links 10 and/or 40 may be a wired connection including, for example, a USB connection, a Firewire connection, an Ethernet connection, or the like and/or a wireless connection such as wireless 802.11n connection, a radio connection, a cell phone connection, or the like. SMS provider 120 may be a device, or service that offers SMS transit. For example, SMS provider 120 may be a service provider that transforms messages to mobile network traffic from other media, or vice versa. This may be done, for example, to allow the transmission or receipt of SMS messages to and from registrant 110.

In another example embodiment, registrant 110 may transmit the keyword to relay communication platform 140 through SMS provider 120 and relay SMS adapter 130. For example, registrant 110 may transmit a text message via communication link 10 to SMS provider 120 where the text message may then be transmitted to relay SMS adapter 130 via communication link 20. The message may then be transmitted to relay communication platform 140 via communication link 30. Communications links 10, 20 and/or 30 may be a wired connection including, for example, a USB connection, a Firewire connection, an Ethernet connection, or the like and/or a wireless connection such as wireless 802.11n connection, a radio connection, a cell phone connection, or the like. Relay SMS adapter 130 may be a computer, a mainframe, a server, or the like.

According to an example embodiment, SMS adapter 130 may include hardware components and/or software components such that relay SMS adapter 130 may be used to translate the text message into a different format. This may be done, for example, to translate a text message into a format that may be easily understood by relay communication platform 140. For example, relay communication platform 140 may be in communication with several SMS providers. Each of the SMS providers may use a different format for sending and receiving text messages. To ensure that the text messages are normalized, a relay SMS adapter 130 may translate text messages received from a SMS provider into a standardized format understood by relay communication platform 140. Additionally, relay SMS adapter 130 may be used to ensure that the text messages are transmitted to relay communication platform 140 in a manner that may be more efficient than would be available if transmitted normally through communication link 40. For example, relay SMS adapter 130 may transmit text messages to relay communication platform 140 via an internet connection that may not be available via communication link 40.

When relay communication platform 140 receives the keyword from the registrant, relay communication platform 140 may identify the phone number from which the text message has been received. Additionally, relay communication platform 140 may retrieve information from a plurality of sources including the registrant's mobile phone number using the techniques described, for example, in the aforementioned U.S. patent application Ser. No. 12/709,312. Relay communication platform 140 may then transmit the identified phone number and/or the acquired information to the relay risk based validation platform 150 to authenticate the identified phone number via communication link 50. Communications link 50 may be a wired connection including, for example, a USB connection, a Firewire connection, an Ethernet connection, or the like and/or a wireless connection such as wireless 802.11n connection, a radio connection, a cell phone connection, or the like.

According to an example embodiment, relay risk based validation platform 150 may include hardware components and/or software components such that relay risk based validation platform 150 may be used to authenticate a phone number. This may be done, for example, to determine whether the identified phone number from which a text message has been received belongs to or is associated with registrant 110. For example, relay risk based validation platform 150 may authenticate an identified phone number from relay communication platform 140.

In one example embodiment, relay risk based validation platform 150 may authenticate the identified phone number by retrieving information regarding registrant 110 from a plurality of sources, such as third party dataset 160, and asking the registrant to provide another piece of information, such as his/her name. Upon retrieving information regarding registrant 110, relay risk based validation platform 150 may analyze the information to determine one or more phone numbers associated with registrant 110. Relay risk based validation platform 150 may then compare the one or more determined phone numbers to the identified phone number, the phone number from which a text message has been received. When the identified phone number matches at least one or more determined phone numbers for registrant 110, relay risk based validation platform 150 may authenticate the identified phone number as belonging to or being associated with registrant 110. When the identified phone number does not match at least one or more determined phone numbers for registrant 110, relay risk based validation platform 150 may notify relay communication platform 140 that the identified phone number may not be authenticated.

In another example embodiment, relay risk based validation platform 150 may authenticate the identified phone number by matching the identified phone number to a phone number that may be included in a plurality of sources, such as third party dataset 160. When a match for the identified phone number has been discovered, relay risk based validation platform 150 may identify one or more individuals associated with the phone number. Relay risk based validation platform 150 may then retrieve information regarding registrant 110. Relay risk based validation platform 150 may then match the information regarding registrant 110 to the one or more individuals associated with the phone number and may authenticate the identified phone number when a match is discovered. When a match is not discovered, relay risk based validation platform 150 may notify relay communication platform 140 that the identified phone number may not be authenticated.

When the phone number has been authenticated, relay communication platform 140 may then link the phone number to any accounts in the registrant's name. When the phone number cannot be authenticated, relay communication platform 140 may send a text message to the registrant that instructs the registrant to call a phone number to activate the card or service or to provide additional authentication information.

As shown in FIG. 6, the system 100 may include third party dataset 160. Third party dataset 160 may be a computer, a server, a database, or the like that belongs to a transaction partner, such as a corporation that has significant consumer transactions; a communication partner, such as a corporation that may have incomplete electronic contact information; or a data partner, such as a company that has data that may be used to enhance an address profile. For example, third party dataset 160 may be a motor vehicle database, or a cell phone service provider database. Information included within third party dataset 160 may include may include electronic contact information for the registrant 110, such as a cell phone number, an e-mail address, an identity of a software application or the like for the registrant 110. Additionally, third party dataset 160 may include demographic information, financial information, consumer information, credit information, personal information, or the like.

Third party dataset 160 may communicate with relay risk based validation platform 150 via communication link 60. Communication link 60 may be a wired connection including, for example, a USB connection, a Firewire connection, an Ethernet connection, or the like and/or a wireless connection such as wireless 802.11n connection, a radio connection, a cell phone connection, or the like.

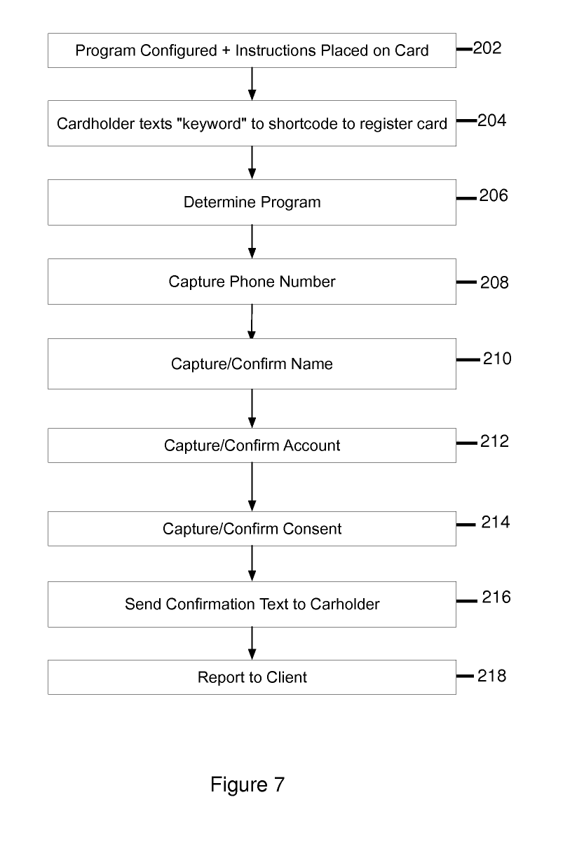

FIG. 7 illustrates an example embodiment of a method for enrolling prepaid cards for services in accordance with the invention. Those skilled in the art will appreciate that the method of claim 7 is generally implemented in software executing on a processor of relay communications platform 140. As shown in FIG. 7, at 202 the vendor (a merchant, issuer, or other entity that desires to provide and/or administrate the prepaid card service) configures the program it desires to provide (e.g., a lost and stolen gift card protection program or loyalty program) and places instructions on the prepaid cards (see FIG. 1) it plans to sell and service under the program. At 204, the vendor receives a keyword texted by the purchaser and/or recipient (“registrant”) of the prepaid card to its designated short code for purposes of activating and/or registering the prepaid card to receive the offered service. At 206, the received keyword is compared against a list of keywords to determine the promotional program under which the prepaid card was purchased. The mobile phone number by which the SMS text message was sent is captured at 208 along with the registrant's name at 210 and account number at 212, if provided (see embodiment of FIGS. 3-5). The registrant's consent to accept the service and/or card activation is captured and confirmed at 214 and a confirmation text is sent to the prepaid card holder at 216. As desired, a report of all enrolled registrants may be generated at 218 and reported to the manager of the promotional campaign.

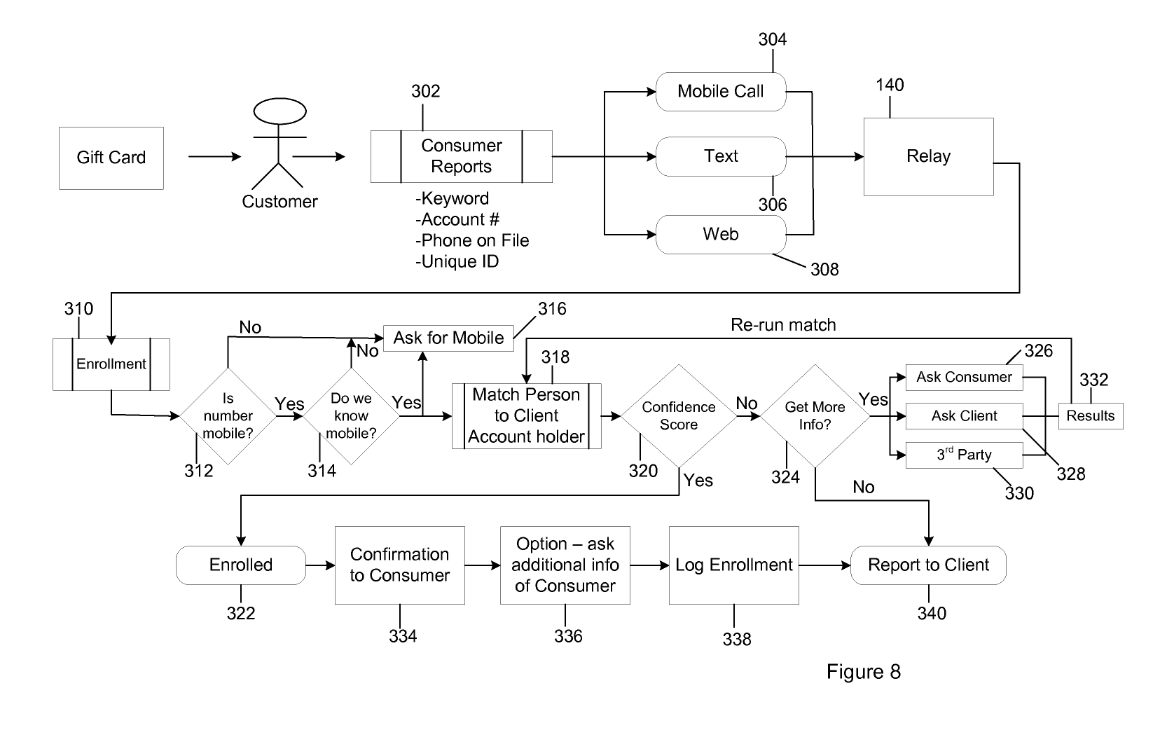

FIG. 8 illustrates an example embodiment of a method for enrolling a prepaid card recipient in a new service where the registrant's mobile phone number is linked to account information for the registrant after the registrant has enrolled in the new service. As illustrated, the registrant chooses to register his/her prepaid card by responding to the activation label on the prepaid card (FIGS. 1 and 2). The registrant's response is captured at 302. The registrant may respond in any of a number of ways. For example, the registrant may respond with a keyword such as “yes” or “no” or a company name, a partial account number, a name, a phone number, a unique identifier, and the like. In accordance with the invention, this data provided by the registrant is not personal to the registrant and may be sent in the open. The response may be sent over any of a number of media including by mobile call at 304, an SMS text message at 306, and/or by an email or other web message at 308. The response is received at the relay communications platform 140 and logged with the corresponding mobile phone number and archived for later reference. The information is stored as evidence of enrollment as appropriate, and a report is prepared for the client, as appropriate, as when the client has requested the relay communications platform 140 to enroll the client's customers in a new service.

The registrant's enrollment response 310 may also be post-linked to the registrant's account data, if the registrant has an account with the vendor. For post-linking the enrollment response to the registrant's account data, the relay communications platform 140 determines at 312 if a mobile phone number has been captured with the registrant's response, as when the registrant replies by SMS texting via his/her mobile phone. If so, relay communications platform 140 determines at 314 if the mobile number is known by, for example, comparing the number against a mobile number database. If the registrant's mobile number is not provided with the registrant's enrollment response, the registrant may be asked for his/her mobile phone number at 316. Once the registrant's mobile number has been acquired, a network match is performed at 318 to link the responding person to the registrant's account. This matching step is preferably performed at 318 by matching the phone number to data provided in a database (not shown) using techniques described, for example, in U.S. patent application Ser. No. 12/709,312, filed Feb. 19, 2010. If a person match is found at 318 and the person matches the registrant data with a sufficient level of confidence at 320 (e.g., with a high confidence score), then, at 322, the response is accepted and the responder is enrolled in the offered service. On the other hand, if at 320 no match is found with sufficient confidence, then more information is gathered at 324 by sending inquiries to the registrant at 326, the entity offering the service at 328, and/or a third party at 330. Any results to these inquiries are gathered at 332 and provided back to the matching process 318 to determine if a higher confidence score for matching the registrant to an account may be obtained. This process may repeat until a match is found at 318. Once the registrant is enrolled at 322, confirmation of enrollment is sent to the registrant at 334 and, optionally, additional information is requested at 336 to complete the enrollment records. The enrollment response is logged into a database at 338 and, as appropriate, a report is sent to the enrolling entity at 340.

As a further example embodiment, the system of FIG. 8 may be used to enroll a registrant in a service where the cardholder is not required to provide personally identifiable information. In this example, the registrant may send a text message to the enrollment short code provided on the prepaid card including non-personal information including: (1) the customer service phone number on the back of the card; (2) that last four digits of the card; (3) and all or part of the registrant's name. Upon receiving the enrollment request, the request and mobile number is logged. A post-link match is performed against the issuer's cardholder data to identify the corresponding account for enrollment. A confirmation text message may be sent out to the registrant confirming the enrollment in the service and the card issuer may receive a report listing the successful and unsuccessful enrolled accounts.

Those skilled in the art will appreciate that if the registrant's response to an enrollment inquiry does not match any of the client's customer data that the relay communications platform 140 may conduct a third party query for information that can be used to identify the registrant and his/her mobile number. If the registrant is identified, the results are provided to the matching process for increasing the confidence score. If no third party query is conducted or no results are found, then it may be determined that this registrant's account cannot be matched, and a report to that effect is generated at 340.

Those skilled in the art also will readily appreciate that many additional modifications are possible in the exemplary embodiment without materially departing from the novel teachings and advantages of the invention. For example, once the prepaid card is enrolled as described herein, the vendor may send promotional material encouraging the prepaid card holder to come into the vendor's store to spend the amount remaining on the prepaid card. Such embodiments are intended to be within the scope of the following claims.

What is claimed:

1. A method of enrolling a prepaid card holder in a service offered by an entity, comprising the steps of:
receiving a keyword, a full or partial card/account number, and/or personal identifying information from a prepaid card holder in response to an invitation to enroll in a service offered by a vendor, retailer or issuer of the prepaid card;
capturing the mobile phone number of the prepaid card holder;
presenting an invitation to the prepaid card holder via a communications medium and instructing the prepaid card holder to enroll from the prepaid card holder's mobile phone; and
capturing the prepaid card holder's response from the prepaid card holder's mobile phone.

2. The method of claim 1, wherein the receiving step includes receiving the keyword via SMS text messaging to an SMS text short code.

3. The method of claim 1, further comprising the steps of determining a promotional program that the prepaid card was sold under, capturing the registrant's name, capturing or confirming the registrant's account number from the prepaid card, and confirming the registrant's consent to enrolling in the offered service.

4. The method of claim 1, wherein the offered service is a lost and stolen protection service for the prepaid card.

5. The method of claim 1, wherein the offered service is a loyalty and/or a discount program.

6. The method of claim 1, further comprising linking account information for the registrant to the prepaid card registrant using the captured mobile phone number.

7. A system for enrolling a prepaid card holder in a service offered by an entity, comprising:
a memory that stores computer executable instructions; and
a processor that processes the computer executable instructions to perform the steps of:
receiving a keyword, a full or partial card/account number, and/or personal identifying information from a prepaid card holder in response to an invitation to enroll in a service offered by a vendor, retailer or issuer of the prepaid card;
capturing the mobile phone number of the prepaid card holder;
presenting an invitation to the prepaid card holder via a communications medium and instructing the prepaid card holder to enroll from the prepaid card holder's mobile phone; and
capturing the prepaid card holder's response from the prepaid card holder's mobile phone.

8. The system of claim 7, wherein the keyword is received via SMS text messaging at an SMS text short code.

9. The system of claim 7, wherein the processor processes additional computer executable instructions to perform the steps of determining a promotional program that the prepaid card was sold under, capturing the registrant's name, capturing or confirming the registrant's account number from the prepaid card, and confirming the registrant's consent to enrolling in the offered service.

10. The system of claim 7, wherein the offered service is a lost and stolen protection service for the prepaid card.

11. The system of claim 7, wherein the offered service is a loyalty and/or a discount program.

12. The system of claim 7, wherein the processor processes additional computer executable instructions to perform the step of linking account information for the registrant to the prepaid card registrant using the captured mobile phone number.
